(19) United States
(12) Patent Application Publication
(10) Pub. No.: US 2021/0177129 A1
(43) Pub. Date: Jun. 17, 2021

(54) BRUSHING ACCESSORY

(71) Applicant: ITZHAK HARAZI, PETAH-TIKVA (IL)

(72) Inventor: ITZHAK HARAZI, PETAH-TIKVA (IL)

(21) Appl. No.: 17/105,546

(22) Filed: Nov. 26, 2020

(30) Foreign Application Priority Data
Dec. 12, 2019 (IL) 271424

(51) Int. Cl. A46B 13/02; A46B 13/00; A47K 7/04

(52) U.S. Cl. CPC A46B 13/02; A46B 13/008; A46B 2200/1033; A46B 2200/1006; A47K 7/04

(57) ABSTRACT

A brushing accessory, including a brushing member having a brush, a motorized member having a motor including a first cog, and a second cog interlaced with the first cog, where the diameter of the second cog is of several centimeters, thereby the second cog moves the brush several centimeters at least back and forth.

### CROSS-REFERENCE TO RELATED APPLICATIONS

This application claims the benefit of priority from Israel Application No. 271424, filed Dec. 12, 2019, the disclosure of which is incorporated herein by reference.

### TECHNICAL FIELD

The invention relates to the field of body soaping and brushing.

### BACKGROUND

Many people rub their backs by others, or by a strap which may, for example, from a sponge affixed to cloth, by a long-handled brush, etc.

However, motorized brushing is not comfortable to the body.

There is a long felt need to provide a solution to the above-mentioned and other problems of the prior art.

### SUMMARY

In accordance with an embodiment of the invention a brushing accessory is provided, including brush and a motor including interlaced cogs, thereby moving the brush back and forth.

### BRIEF DESCRIPTION OF THE DRAWINGS

Embodiments, features, and aspects of the invention are described herein in conjunction with the following drawings, in which:

FIG. 1 is in an exploded perspective view of a brushing accessory according to one embodiment of the invention;

FIG. 2 is the exploded perspective view of FIG. 1 from another angle of view;

FIG. 3 is a sectional view of the motorized and brushing members of FIG. 1;

FIG. 4 is a top view of the opposing cogs at the state of FIG. 3;

FIG. 5 is the top view of the opposing cogs upon rotating 90 degrees;

FIG. 6 depicts 4 locations of one of the pins of FIG. 2, and the disposition of the brush member for each of the dispositions;

FIG. 7 is a side view of the brushing accessory of FIG. 1 including an elevator; and

FIG. 8 is a front view of the brushing accessory of FIG. 7.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

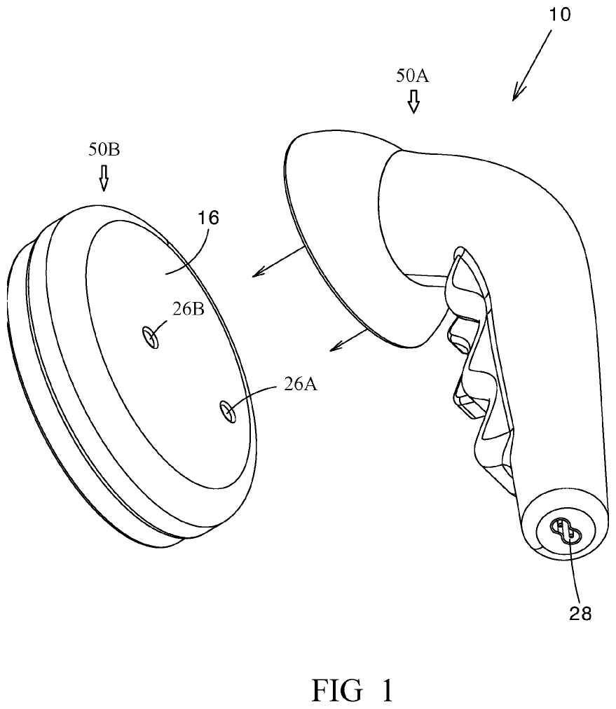

FIG. 1 is in an exploded perspective view of a brushing accessory according to one embodiment of the invention.

A brushing accessory 10 such as for soaping, according to one embodiment of the invention, includes a motorized member 50A and a brushing member 50B, including holes 26A and 26B.

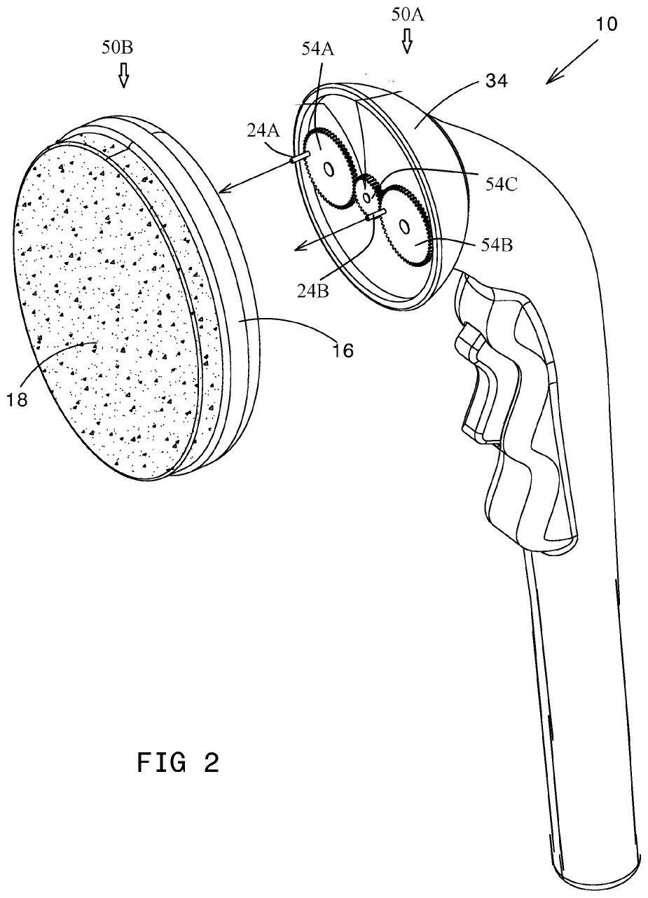

FIG. 2 is the exploded perspective view of FIG. 1 from another angle of view.

Connecting motorized member 50A to brushing member 50B inserts pin 24A of motorized member 50A into hole 26A and pin 24B into hole 26B of brushing member 50B.

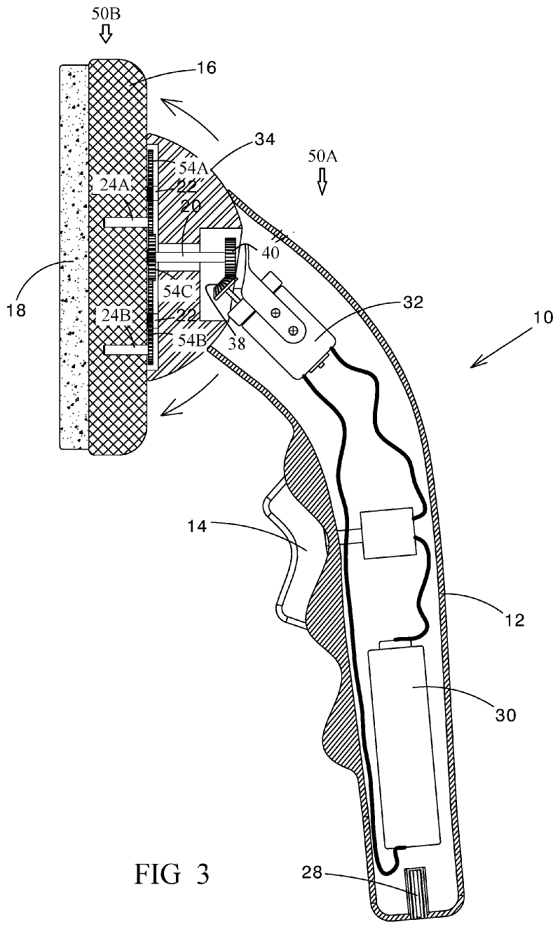

FIG. 3 is a sectional view of the motorized and brushing members of FIG. 1.

A motor 32 rotates a central cog 54C.

Referring again to FIG. 2, equal cogs 54A and 54B are interlaced to central cog 54C, one opposite to the other, thus they rotate at equal speeds.

The interlacing of cogs 54A and 54B to central cog 54C disposes pins 24A and 24B at the same side.

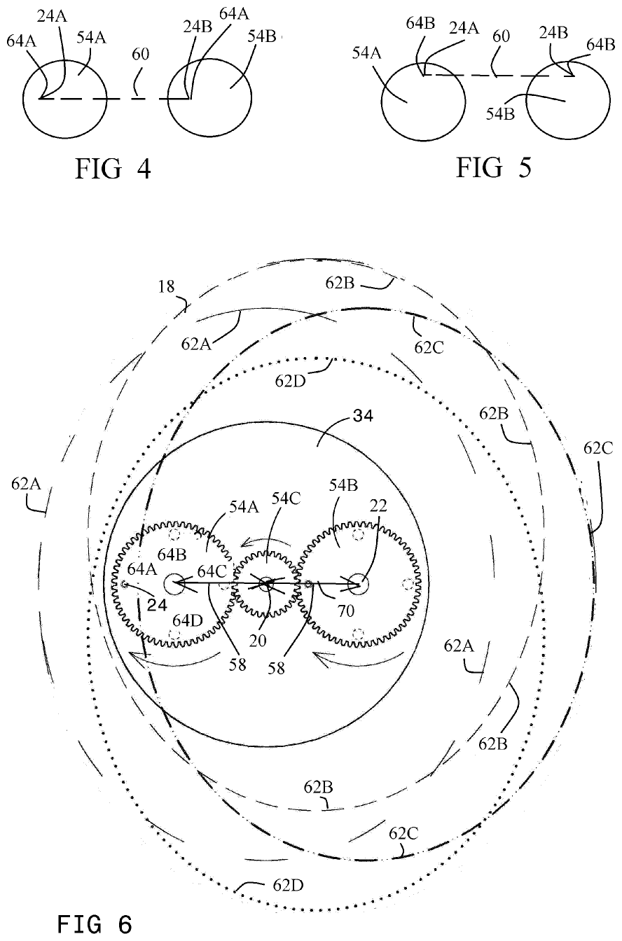

FIG. 4 is a top view of the opposing cogs at the state of FIG. 3.

Pins 24A and 24B are shown disposed at the left, enumerated 64A.

FIG. 5 is the top view of the opposing cogs upon rotating 90 degrees.

Since cogs 54A and 54B are equal, and pins 24A and 24B are equally distanced 58, once pin 24A is disposed up enumerated 64B, pin 24B as well is disposed up, and the virtual line 60 therebetween maintains its angle, to the angle of the state of FIG. 5, being horizontal according to the examples.

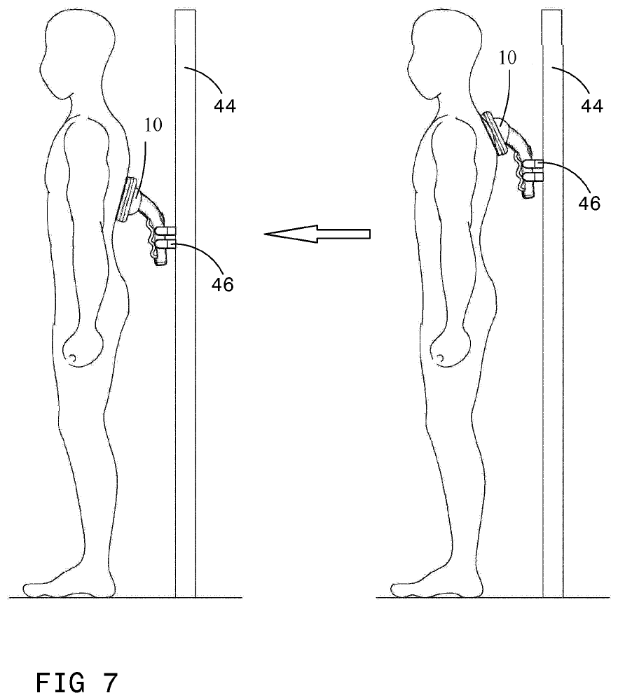

FIG. 6 depicts 4 locations of one of the pins of FIG. 2, and the disposition of the brush member for each of the dispositions.

Pins 24A and 24B extend from cogs 54A and 54B respectively, and having the equal distances 58 between center 20 and center 22 of the cogs.

In case pin 24A is disposed at location 64A, brush 18 is disposed at zone 62A; in case pin 24A is disposed at location 64B, brush 18 is disposed at zone 62B; in case pin 24A is disposed at location 64C, brush 18 is disposed at zone 62C; and in case pin 24A is disposed at location 64D, brush 18 is disposed at zone 62D.

Zone 62A is left to zone 62C, thus providing a left to right back and forth motion to brush 18; zone 62B is above zone 62D, thus providing a top to bottom back and forth motion to brush 18; and zone 62A is below and left to zone 62B, thus providing a 45 degrees back and forth motion to brush 18. Considering the states between these 4 shown states, brush 18 moves back and forth in all directions.

This brushing movement is further advantaged in applying equal distances and speeds to all points of the user's body, being in contrast to symmetric rotating of a brush, or even to eccentric rotating of a brush applying a higher distance and speed away from the center of the rotation.

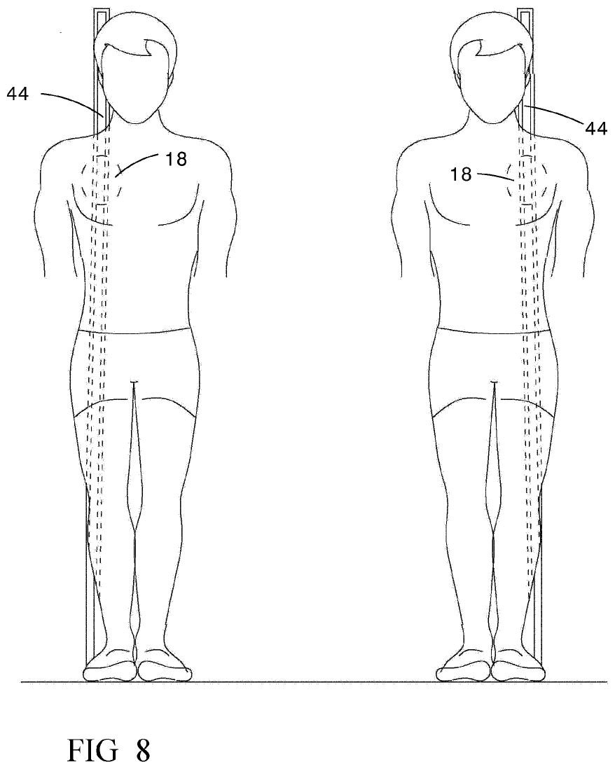

FIG. 7 is a side view of the brushing accessory of FIG. 1 including an elevator.

Brushing accessory 10 may include an elevator 44, for brushing various heights.

FIG. 8 is a front view of the brushing accessory of FIG. 7.

The user may move left and right in relation to the elevator of FIG. 7.

Thus, in one aspect, the invention is directed to a brushing accessory (10), including:
a brushing member (50B), including a brush (18); and
a motorized member (50A), including a motor (32) including a first cog (54C), and including a second cog (54A) interlaced with the first cog (54C),
where the diameter of the second cog (54A) is of several centimeters,
thereby the second cog (54A) moves the brush (18) several centimeters at least back and forth.

The brushing accessory (10) may further include:
a third cog (54B) interlaced with the first cog (54C),
thereby the back and forth moving of the brush is along all directions.

Centers of (22,20) of the first, second and third cogs may be disposed along a virtual line (60).

The second (54A) and third (54B) cogs may be equal.

The brush (18) may be connected to a point (24A) of the second cog (54A) and to a point (24B) of the third cog (54B),
and the points (24A,24B) may be equally distanced (58) each from the center (22) of that cog.

The interlacing of the second (54A) and third (54B) cogs may dispose the points (24A,24B) at an equal side.

In the figures and/or description herein, the following reference numerals (Reference Signs List) have been mentioned:
numeral 10 denotes the brushing accessory according to one embodiment of the invention;
12: package;
14: operating button;
16: head of brush;
18: brush, sponge, etc.;
20: center and hinge of cog 54C;
22: center and hinge of cog 54A and 54B;
24A,24B: pins or depressions of motorized member 50A, for transferring motion;
26A,26B: pins or depressions of brushing member 50B, for receiving motion from points 24A,24B respectively;
28: electric socket;
30: battery;
32: motor;
34: joint allowing rotating thereof in relation to package 12;
38,40: cogs;
44: elevator;
46: rack;
50A: motorized member;
50B: brushing member;
54A,54B,54C: cogs;
58: distances between center 20 and center 22 of cogs;
60: virtual line;
62A,62B,62C,62D: temporal zone of brush 18;
64A,64B,64C,64D: temporal location of pin 24A;

The foregoing description and illustrations of the embodiments of the invention have been presented for the purpose of illustration, and are not intended to be exhaustive or to limit the invention to the above description in any form.

Any term that has been defined above and used in the claims should be interpreted according to this definition.

The reference numbers in the claims are not a part of the claims, but rather used for facilitating the reading thereof. These reference numbers should not be interpreted as limiting the claims in any form.

What is claimed is:

1. A brushing accessory, comprising:
a brushing member, comprising a brush; and
a motorized member, comprising a motor comprising a first cog.

2. The brushing accessory according to claim 1, further comprising:
a second cog interlaced with said first cog,
thereby said second cog moves said brush at least back and forth.

3. The brushing accessory according to claim 2, further comprising:
a third cog interlaced with said first cog,
thereby said back and forth moving of said brush is along all directions.

4. The brushing accessory according to claim 3, wherein centers of said first, second and third cogs are disposed along a virtual line.

5. The brushing accessory according to claim 3, wherein said second and third cogs are equal.

6. The brushing accessory according to claim 3,
wherein said brush is connected to a point of said second cog and to a point of said third cog, and
wherein said points are equally distanced each from the center of that cog.

7. The brushing accessory according to claim 6, wherein said interlacing of said second and third cogs dispose said points at an equal side.
